(19) United States
(12) Patent Application Publication
(10) Pub. No.: US 2006/0080068 A1
(43) Pub. Date: Apr. 13, 2006

(54) System and method for efficient model order reduction in electric and electronic circuit design

(75) Inventors: Peter Feldmann, New York, NY (US); Ying Liu, Austin, TX (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/961,365

(22) Filed: Oct. 7, 2004

(51) Int. Cl. G06F 17/10

(52) U.S. Cl. 703/2

(57) ABSTRACT

The present invention comprises a system and method for reducing the order of models used to simulate complex electric circuits and linear systems. In particular, the method of the present invention comprises formulating expressions relating the input and output terminals of a complex electric circuit, wherein the expressions comprise a first model of the electric circuit; performing mathematical operations on the first model to reveal correlations between at least two input terminals or between at least two output terminals; and substituting a reduced order second model for the original first model, whereby the reduced order second model eliminates some or all aspects of correlations between input terminals or between output terminals. The system of the present invention comprises a computer system for performing model order reduction.

### FIELD OF THE INVENTION

The present invention generally concerns electric and electronic circuit design, and more particularly concerns software programs and computer systems for use in circuit design. Software programs and computer systems in accordance with the present invention provide model order reduction methods and apparatus that significantly reduce the computational overhead associated with circuit simulation in computer-aided design. The methods and apparatus of the present invention are similarly applicable for use in model order reduction of models of complex linear systems.

### BACKGROUND OF THE INVENTION

Computer-aided design tools for use in circuit design are well-known and provide many advantages to circuit designers. In particular, the increasing sophistication of such tools has eliminated the need for the building of test circuits until the design process is well advanced. Further, integrated circuits (e.g., microprocessors) can only be designed using such tools since it is in no way practical to construct test models of circuits that will be implemented in semiconductor material, and will consist of many millions of circuit elements.

It is not surprising that there is significant computational overhead associated with the computer modeling of large integrated circuits. Even with the advent of increasingly fast microprocessors, design workstations still may be overburdened in situations where large circuits are being modeled. Hence, those skilled in the art are always seeking improved methods that significantly reduce the burden of modeling on computer resources.

One such method is called “model order reduction” (hereinafter “MOR”), which has become an established method for analyzing and compressing model information concerning linear circuits and systems. MOR relies on the fact that in many practical situations, the designer is only interested in the behavior of the circuit at its input and output terminals. Moreover, the number of these inputs and outputs is much smaller than the total size of the state vector (approximated by the number of circuit nodes). For example, in the analysis of delay or noise in on-chip interconnects, the propagation of signals that connect logic gates are studied. These wires may have numerous features: bends, crossings, vias, etc., and are modeled by circuit extractors in terms of a large number of connected circuit elements: capacitors, resistors and more recently inductors. Nevertheless, in many practical situations only the signal behavior at the terminal inputs and outputs of the gates is of interest. MOR techniques generate compact models of circuits that approximate well circuit behavior at the input and output terminals but ignore circuit behavior at internal nodes.

Traditional MOR techniques substitute the original large but sparse matrices used in the mathematical modeling of linear circuits by models that approximate the behavior of the circuit at its terminals, and use significantly smaller matrices. Unfortunately these small MOR matrices become dense as the number of terminals increases, thus canceling the benefits of size reduction.

As a result, the efficiency of model order reduction degrades as the number of external terminals to the circuit increases. The reason for this degradation is fundamental. A multi-terminal circuit is described by an m x m matrix-valued transfer function, where m is the number of external terminals. Each entry in the transfer function matrix characterizes the interaction between a pair of two terminals O(m²) of such interactions. Moreover, in general, there is no basis in the assumption that any of the interactions is magnitude-wise insignificant, therefore the matrix-valued transfer function must be assumed to be fully populated. Any reduced-order model must approximate, in some sense, this matrix-valued transfer function. Therefore, unless some special properties of the circuit are exploited, the complexity of the reduced-order model is at least O(m²), which for a circuit with numerous inputs and outputs may approach or even surpass the complexity of working with the original, un-reduced, circuit equations.

Thus, those skilled in the art seek improvements to model order reduction methods that exploit special properties of mathematical representations of complex circuits to significantly reduce the computational overhead associated with the modeling of complex electric circuits. Such improved methods would provide simplified representations of the terminal characteristics of circuits, even as the number of internal nodes in the circuit increases.

Many of the same problems are likewise encountered in the modeling of linear systems (both discrete and analogue). Accordingly, model order reduction methods and apparatus applicable to models of linear systems are also sought.

### SUMMARY OF THE PREFERRED EMBODIMENTS

The foregoing and other problems are overcome, and other advantages are realized, in accordance with the presently preferred embodiments of these teachings.

The present invention comprises systems and methods for simplifying the modeling of complex circuits. In particular, a first alternate embodiment of the present invention comprises a signal-bearing medium tangibly embodying a program of machine-readable instructions executable by a digital processing apparatus of a computer system to perform operations comprising model order reduction of a complex electric circuit, the operations comprising: formulating a set of expressions that describes the input and output characteristics of the complex electric circuit, wherein the set of expressions comprises a first model of the complex electric circuit; performing mathematical operations on the first model of the electric circuit to determine whether at least one correlation in response behavior exists between at least two input terminals; and, if at least one correlation is found, generating a reduced-order second model of the electric circuit by removing from the first model aspects associated with correlated input terminals.

As used herein, “electric circuit” generically refers to electric and electronic circuits. In addition, as used herein “complex electric circuit” refers to a particularly complicated electric or electronic circuit, and not to imaginary mathematical aspects (e.g., aspects represented by complex numbers) of such an electrical circuit, although “a model of a complex electric circuit” as used herein may certainly comprise, in part, imaginary mathematical aspects (e.g., aspects represented by complex numbers).

A second alternate embodiment of the present invention comprises a signal-bearing medium tangibly embodying a program of machine-readable instructions executable by a digital processing apparatus of a computer system to perform operations comprising model order reduction of a complex electric circuit, the operations comprising: formulating a set of expressions that describes the input and output characteristics of the complex electric circuit, wherein the set of expressions comprises a first model of the complex electric circuit; performing mathematical operations on the first model of the electric circuit to determine whether at least one correlation in response behavior exists between at least two output terminals; and, if at least one correlation is found, generating a reduced-order second model of the electric circuit by removing from the first model aspects associated with correlated output terminals.

A third alternate embodiment of the present invention comprises a signal-bearing medium tangibly embodying a program of machine-readable instructions executable by a digital processing apparatus of a computer system to perform operations comprising model order reduction of a complex electric circuit, the operations comprising: formulating a set of expressions that describes the input and output characteristics of the complex electric circuit, wherein the set of expressions comprises a first model of the complex electric circuit; performing mathematical operations on the first model of the electric circuit to determine whether at least one correlation in response behavior exists between at least two input terminals or between at least two output terminals; and, if at least one correlation is found, generating a reduced-order second model of the complex electric circuit by removing from the first model aspects associated with correlated input terminals or correlated output terminals.

In one variant of the third alternate embodiment of the present invention, generating a reduced-order second model further comprises substituting a lower rank second model of the complex electric circuit for the first model of the electric circuit.

In another variant of the third alternate embodiment of the present invention, performing mathematical operations on the first model of the complex electric circuit further comprises: performing linear algebraic manipulations on the first model of the electric circuit to reveal at least one correlation between at least two input terminals or between at least two output terminals.

In a further variant of the third alternate embodiment of the present invention, performing linear algebraic manipulations further comprises: performing singular value decomposition on the first model.

In yet another variant of the third alternate embodiment of the present invention, generating a reduced-order second model of the electric circuit further comprises: eliminating from the singular value decomposition of the first model of the complex electric circuit null singular values associated with correlated input terminals or correlated output terminals; and creating a second reduced-order model of the complex electric circuit from the non-zero singular values of the singular value decomposition of the first model of the complex electric circuit.

In a still further variant of the third alternate embodiment of the present invention, generating a reduced-order second model of the complex electric circuit further comprises: selecting a suitable tolerance for modeling the complex electric circuit; eliminating from the singular value decomposition of the first model of the complex electric circuit singular values not needed to achieve the desired modeling tolerance; and creating a second reduced-order model of the complex electric circuit from the retained singular values.

A fourth alternate embodiment of the present invention comprises a signal-bearing medium tangibly embodying a program of machine-readable instructions executable by a digital processing apparatus of a computer system to perform operations comprising model order reduction of a complex electric circuit, the operations comprising: selecting which response characteristic of the complex electric circuit to model; formulating a set of expressions of sufficient accuracy to simulate the selected response characteristic at the input and output terminals of the complex electric circuit, wherein the set of expressions comprises a first model of the electric circuit; performing mathematical operations on the first model of the complex electric circuit to determine whether at least one correlation in response behavior exists between at least two input terminals or between at least two output terminals; and, if at least one correlation is found, generating a reduced-order second model of the electric circuit by removing from the first model aspects associated with correlated input terminals or correlated output terminals.

In one variant of the fourth alternate embodiment of the present invention, generating a reduced-order second model further comprises: substituting a lower-rank second model of the complex electric circuit for the first model of the complex electric circuit.

In another variant of the fourth alternate embodiment of the present invention, performing mathematical operations on the first model of the complex electric circuit further comprises: performing linear algebraic manipulations on the first model of the complex electric circuit to reveal at least one correlation between at least two input terminals or between at least two output terminals.

In a further variant of the fourth alternate embodiment of the present invention, performing linear algebraic manipulations further comprises: performing singular value decomposition on the first model.

In yet another variant of the fourth alternate embodiment of the present invention, generating a reduced-order second model of the complex electric circuit further comprises: eliminating from the singular value decomposition of the first model of the complex electric circuit null singular values associated with correlated input terminals or correlated output terminals; and creating a second reduced-order model of the complex electric circuit from the non-zero singular values of the singular value decomposition of the first model of the electric circuit.

In a still further variant of the fourth alternate embodiment of the present invention, generating a reduced-order second model of the complex electric circuit further comprises: selecting a suitable tolerance for modeling the complex electric circuit; eliminating from the singular value decomposition of the first model of the complex electric circuit singular values not needed to achieve the desired modeling tolerance; and creating a second reduced-order model of the electric circuit from the retained singular values.

A fifth alternate embodiment of the present invention comprises a method for determining a reduced-order model of a complex electric circuit, the method comprising: formulating a set of expressions that describes the input and output characteristics of the complex electric circuit, wherein the set of expressions comprises a first model of the complex electric circuit; performing mathematical operations on the first model of the electric circuit to determine the identity of at least two input terminals which are correlated in their response behavior and the identity of at least two output terminals which are correlated in their response behavior; and generating a reduced-order second model of the complex electric circuit by eliminating from the first model aspects associated with correlated input terminals and correlated output terminals.

In one variant of the fifth alternate embodiment of the present invention, the method further comprises substituting a lower rank second model of the complex electric circuit for the first model of the complex electric circuit.

In another variant of the fifth alternate embodiment of the present invention, the method further comprises performing linear algebraic manipulations on the model of the complex electric circuit to reveal correlations between at least two input terminals and correlations between at least two output terminals.

In a further variant of the fifth alternate embodiment of the present invention, the method further comprises performing singular value decomposition on the first model.

In yet another variant of the fifth alternate embodiment of the present invention, the method further comprises: eliminating from the singular value decomposition of the first model of the complex electric circuit null singular values associated with correlated input terminals and correlated output terminals; and creating a second reduced-order model of the electric circuit from the non-zero singular values of the singular value decomposition of the first model of the complex electric circuit.

In a still further variant of the fifth alternate embodiment of the present invention, the method further comprises: selecting a suitable tolerance for modeling the complex electric circuit; eliminating from the singular value decomposition of the first model of the electric circuit singular values not needed to achieve the desired modeling tolerance; and creating a second reduced-order model of the complex electric circuit from the retained singular values.

A sixth alternate embodiment of the present invention comprises a method for determining a reduced-order model of the complex electric circuit, wherein the method comprises: selecting which response characteristics of the complex electric circuit to model, wherein the response characteristics vary from simple to complex; formulating a set of expressions of sufficient accuracy to simulate the selected response characteristics at the input and output terminals of the complex electric circuit, wherein the set of expressions comprises a first model of the electric circuit; performing mathematical operations on the first model of the electric circuit to determine the identity of at least two input terminals which are correlated in their response behavior and the identity of at least two output terminals which are correlated in their response behavior; and generating a reduced-order second model of the electric circuit by eliminating from the first model aspects associated with correlated input terminals and correlated output terminals.

In one variant of the sixth alternate embodiment of the present invention, the chosen response characteristics correspond to various moments of the complex electric circuit. For example, in some situations it may be desired to model the zero-order moment (i.e., the DC response) of the complex electric circuit; in other situations it may be desired to model the first-order moment of the complex electric circuit (i.e., the delay response); and in other situations it may be desired to model higher order moments.

In another variant of the sixth alternate embodiment of the present invention, a lower rank model of the input and output terminal characteristics is substituted for the first model of the electric circuit.

In a further variant of the sixth alternate embodiment of the present invention, the method further comprises performing linear algebraic manipulations on the first model of the electric circuit to reveal correlations between input terminals and correlations between output terminals.

In yet another variant of the sixth alternate embodiment of the present invention, the method further comprises: performing singular value decomposition on the first model.

In a still further variant of the sixth alternate embodiment of the present invention, the method further comprises eliminating from the singular value decomposition of the first model of the complex electric circuit null singular values associated with correlated input terminals and correlated output terminals; and creating a second reduced order model of the complex electric circuit from the non-zero singular values of the singular value decomposition of the first model of the complex electric circuit.

In another variant of the sixth alternate embodiment of the present invention, the method further comprises: selecting a suitable tolerance for modeling the complex electric circuit; eliminating from the singular value decomposition of the first model of the electric circuit singular values not needed to achieve the desired modeling tolerance; and creating a second reduced-order model of the electric circuit from the retained singular values.

A seventh alternate embodiment of the present invention comprises a computer system for performing model order reduction on a model of a complex electric circuit, wherein the computer system comprises: at least one memory to store at least (1) a description of the complex electric circuit and (2) at least one program of machine readable instructions comprising operations which perform model order reduction on models of complex electric circuits when the at least one program is executed; at least one processor coupled to the at least one memory, wherein the at least one processor performs at least the following operations when the at least one program is executed: formulating a set of expressions from the description of the complex electric circuit that describes the input and output characteristics of the complex electric circuit, wherein the set of expressions comprises a first model of the complex electric circuit; performing mathematical operations on the first model of the complex electric circuit to determine whether at least one correlation exists between at least two input terminals or between at least two output terminals; and, if at least one correlation is found, generating a reduced-order second model of the complex electric circuit by removing from the first model aspects associated with the correlated input terminals or correlated output terminals.

In one variant of the seventh alternate embodiment of the present invention, generating a reduced-order model further comprises: substituting a lower-rank second model of the complex electric circuit for the first model of the complex electric circuit.

In another variant of the seventh alternate embodiment of the present invention, performing mathematical operations on the first model of the complex electric circuit further comprises: performing linear algebraic manipulations on the first model of the complex electric circuit to reveal at least one correlation between at least two input terminals or between at least two output terminals.

In a further variant of the seventh alternate embodiment of the present invention, performing linear algebraic manipulations on the first model of the complex electric circuit further comprises: performing singular value decomposition on the first model of the complex electric circuit.

In yet another variant of the seventh alternate embodiment of the present invention, generating a reduced-order second model of the complex electric circuit further comprises: eliminating from the singular value decomposition of the first model of the complex electric circuit null singular values associated with correlated input terminals or correlated output terminals; and creating a second reduced-order model of the complex electric circuit from the non-zero singular values of the singular value decomposition of the first model of the complex electric circuit.

In a still further variant of the seventh alternate embodiment of the present invention, generating a reduced-order second model of the complex electric circuit further comprises: recalling a specified tolerance for modeling the complex electric circuit; eliminating from the singular value decomposition of the first model of the complex electric circuit singular values not needed to achieve the desired modeling tolerance; and creating a second reduced-order model of the complex electric circuit from the retained singular values.

In another variant of the seventh alternate embodiment of the present invention, the at least one memory comprises at least one remote database accessible over the internet, wherein the description of the complex electric circuit is stored in the at least one remote database.

In a further variant of the seventh alternate embodiment of the present invention, the at least one memory comprises at least one remote database accessible over the internet, wherein the at least one program for performing model order reduction is stored in the at least one remote database.

An eighth alternate embodiment of the present invention comprises a computer system for performing model order reduction on a complex electric circuit, wherein the computer system comprises: at least one memory to store at least (1) a description of the complex electric circuit and (2) at least one program of machine-readable instructions comprising operations which perform model order reduction on models of complex electric circuits when executed; at least one processor coupled to the at least one memory, wherein the at least one processor performs at least the following operations when the at least one program is executed: recalling a user-specified selection corresponding to a desired response characteristic of the complex electric circuit; wherein that desired response characteristic of the complex electric circuit will be modeled by the computer system; formulating a set of expressions of sufficient accuracy to simulate the selected response characteristic at the input and output terminals of the complex electric circuit, wherein the set of equations comprises a first model of the electric circuit; performing mathematical operations on the first model of the complex electric circuit to determine whether at least one correlation exists between at least two input terminals or between at least two output terminals; and, if at least one correlation is found, generating a reduced-order second model of the complex electric circuit by removing from the first model aspects associated with the correlated input terminals or correlated output terminals.

In one variant of the eighth alternate embodiment of the present invention, the chosen response characteristics correspond to various moments of the complex electric circuit. For example, in some situations it may be desired to model the zero-order moment (i.e., the DC response) of the complex electric circuit; in other situations it may be desired to model the first-order moment of the complex electric circuit (i.e., the delay response); and in further situations it may be desired to model higher order moments. In yet other situations, combined moments may be modeled (e.g., the DC and delay response), or frequency-shifted moments may be modeled.

In another variant of the eighth alternate embodiment of the present invention, generating a reduced-order second model of the complex electric circuit further comprises: substituting a lower rank second model of the complex electric circuit for the first model of the complex electric circuit.

In a further variant of the eighth alternate embodiment of the present invention, performing mathematical operations on the first model of the complex electric circuit further comprises: performing linear algebraic manipulations on the first model of the complex electric circuit to reveal at least one correlation between at least two input terminals or between at least two output terminals.

In yet another variant of the eighth alternate embodiment of the present invention, performing linear algebraic manipulations on the first model of the complex electric circuit further comprises: performing singular value decomposition on the first model of the complex electric circuit.

In a still further variant of the eighth alternate embodiment of the present invention, generating a reduced-order second model of the complex electric circuit further comprises: eliminating from the singular value decomposition of the first model of the complex electric circuit null singular values associated with correlated input terminals or correlated output terminals; and creating a second reduced order model of the complex electric circuit from the non-zero singular values of the singular value decomposition of the first model of the electric circuit.

In another variant of the eighth alternate embodiment of the present invention, generating a reduced-order second model of the complex electric circuit further comprises: recalling a user-specified tolerance for modeling the complex electric circuit; eliminating from the singular value decomposition of the first model of the complex electric circuit singular values not needed to achieve the desired modeling tolerance; and creating a second reduced-order model of the complex electric circuit from the retained singular values.

The methods and apparatus of the present invention are also applicable to model order reduction of linear systems. Accordingly, a ninth alternate embodiment of the present invention comprises a signal-bearing medium embodying a program of machine-readable instructions executable by a digital processing apparatus of a computer system to perform operations comprising model order reduction of a linear system, the operations comprising: formulating a set of expressions that describe the input and output characteristics of the linear system, wherein the set of expressions comprises a first model of the linear system; performing mathematical operations on the first model of the linear system to determine whether at least one correlation in response behavior exists between at least two inputs or between at least two outputs; and, if at least one correlation is found, generating a reduced-order second model of the linear system by removing from the first model aspects associated with correlated inputs or correlated outputs.

In one variant of the ninth alternate embodiment, the linear system further comprises an analogue system.

In another variant of the ninth alternate embodiment, the linear system further comprises a discrete system.

The foregoing alternate embodiments of the present invention are exemplary and non-limiting. For example, one of ordinary skill in the art will understand that one or more aspects or steps from one alternate embodiment can be combined with one or more aspects or steps from another alternate embodiment to create another embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a block diagram depicting the steps of a method in accordance with a variant of the first alternate embodiment of the present invention;

FIG. 2 depicts a block diagram of a computer system for practicing the methods of the present invention;

FIG. 3 depicts the DC response of a mesh;

FIG. 4 depicts the Elmore delay of a mesh;

FIG. 5 depicts the error incurred in a low-rank approximation of the DC moment of a mesh in accordance with the present invention;

FIG. 6 depicts the error incurred in a low-rank approximation of the delay moment of a mesh in accordance with the present invention;

FIG. 7 is a block diagram depicting the steps of a method in accordance with a variant of the sixth alternate embodiment of the present invention; and

FIG. 8 compares the response of a circuit modeled in accordance with the method of the present invention with the exact response.

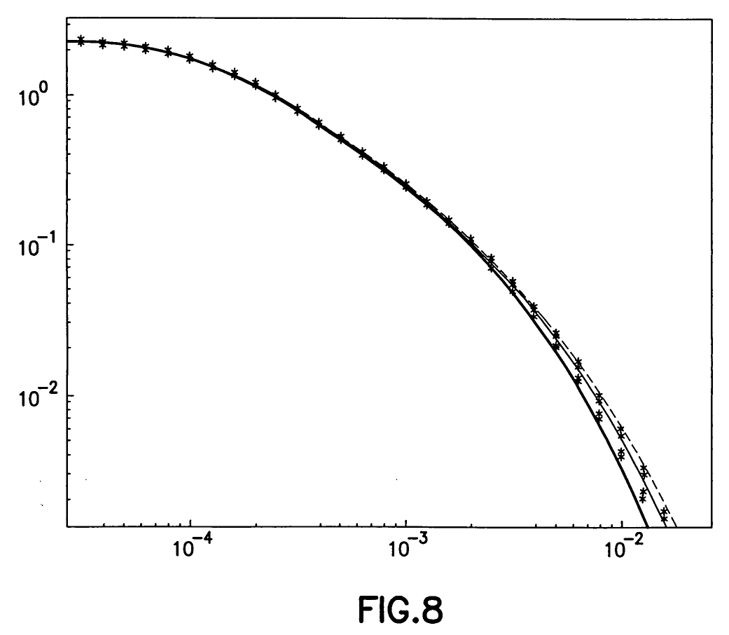

### DETAILED DESCRIPTION OF THE PREFERRED EMBODIMENTS

Before proceeding with a description of the preferred embodiments of the present invention, the essence of MOR methods will be described. It is of interest to compute the reduced-order model for a linear circuit characterized by a large number of input and output terminals. The general state-space formulation of the circuit is

$$C \frac{ⅆ}{ⅆ t} x + Gx = Mu \\ y = {N}^{T} x \qquad ( 1 )$$

Here C and G are n×n matrices describing the reactive and dissipative parts of the circuit, respectively. M is a n×p matrix that defines the input ports, and N is a n×q matrix that defines the outputs. For most circuits these matrices are quite sparse.

A large class of MOR methods operates on the Laplace-domain transfer function of the multi-port circuit. The Laplace transform of the input/output transfer function has the expression
H(s)=N^{T}(G+sC)⁻¹ M, (2)
and is in fact a q×p matrix-valued rational function.

Pade-based MOR algorithms known to those skilled in the art operate on the original circuit matrices G, C, M, N and compute models described by smaller matrices. The transfer function of the reduced-order models approaches the original in the Pade approximation sense
H(s)≈H₁(s)=Nₗ^{T}(Gₗ+sCₗ)⁻¹Mₗ. (3)

In this reduced-order model (3) Gₗ and Cₗ are l×l matrices where l depends on the number of I/O ports and the order of approximation. Typically, 1 is much smaller than n, the size of the original system matrices and, therefore, the reduced-order model is expressed in terms of significantly smaller matrices.

However, reduced-order model matrices may be much denser. The number of non-zero entries in the reduced-order model matrices is increasing rapidly with the number of I/O ports and is the order of O(pq), while for typical circuits, the system matrices G and C are very sparse, having a number of non-zero entries of order O(n). This situation causes the benefits of model-order reduction (compactness and computational efficiency) to vanish rapidly as the number of I/O ports is increased.

A method in accordance with preferred embodiments of the present invention begins with algebraic manipulation. Let G=QJQ^{T} be the LDL^{T} decomposition of the symmetric G matrix, where J is a simple matrix, block diagonal with 1×1 and 2×2 diagonal blocks. When G is a symmetric positive definite matrix the Cholesky decomposition is performed and J becomes the identity matrix.

$$\begin{matrix}H ( s ) = {{N}^{T} ( G + sC )}^{- 1} M \\ = {{N}^{T} [ Q ( J + s \underbrace{{Q}^{- 1} {CQ}^{- T}}_{A} ) {Q}^{T} ]}^{- 1} M \\ = {N}^{T} {{Q}^{- T} ( J + sA )}^{- 1} {Q}^{- 1} M\end{matrix}$$

The transfer function reduces to the standard form
H(s)=L^{T}(J+sA)⁻¹R (4)
where A=Q⁻¹CQ^{-T}, L=Q⁻¹N, and R=Q⁻¹M. In general, the symmetry of the formulation is maintained. Therefore the n×(m=p+q) matrix B obtained from the juxtaposition of matrices L and R, B=[LR] is introduced. Using selection matrices E_{L} and E_{R} the original L and R matrices can be recovered
L=BE_{L}
R=BE_{R} (5)
The transfer function can now be expressed in terms of the juxtaposed matrix B
H(s)=E_{L}^{T}B^{T}(J+sA)⁻¹BE_{R} (6)

The matrix B encodes all the input/output port definitions. Obviously in many applications all the inputs and outputs are not independent. On the contrary, typically there is a large degree of correlation between the various inputs and outputs. Such a correlation would manifest itself in the matrix B having highly dependent entries, or in other words with B being well approximated by a lower rank matrix. In an actual complex electric or electronic circuit, such correlations would manifest themselves when, e.g., two output terminals have similar or nearly identical responses to the same input excitation. In such situations, it is inefficient and unnecessary to model both output terminals. Note that in the current formulation, B only contains DC (zero frequency) information on the system and the sparsification will be based on correlation that manifests itself at DC. The algorithm can be extended to use more complicated response correlations.

In one method in accordance with the present invention, the low-rank approximation to B is computed through the singular value decomposition, (SVD),
B=UΣV^{T} (7)
Where Σ=diag(σ₁, . . . ,σₘ), and U and V are orthogonal matrices. In many important situations there will be a relatively small number of dominant singular values, say σ₁, . . . ,σᵣ, r [symbol] m, and the error caused by setting the remaining singular values will be relatively small. In these cases
B=UΣV^{T}≈UᵣVᵣ^{T} (8)
and Uᵣ and Vᵣ are n×r and r×r matrices respectively. The transfer function becomes

$$H ( s ) \approx {E}_{L}^{T} {V}_{r} \underbrace{{U}_{r}^{T} {( J + sA )}^{- 1} {U}_{r}}_{{H}_{r} ( s )} {V}_{r}^{T} {E}_{R} \qquad ( 9 )$$

The standard model order reduction techniques can now be applied to
Hᵣ(s)=Uᵣ^{T}(J+sA)⁻¹Uᵣ (10)
which is just a r×r matrix transfer function, and obtain \tilde{H}ᵣ(s). The complete transfer function is approximated by
H(s)≈E_{L}^{T}Vᵣ\tilde{H}ᵣ(s)Vᵣ^{T}E_{R} (11)
where all the matrices involved have O(r²) non-zero entries.

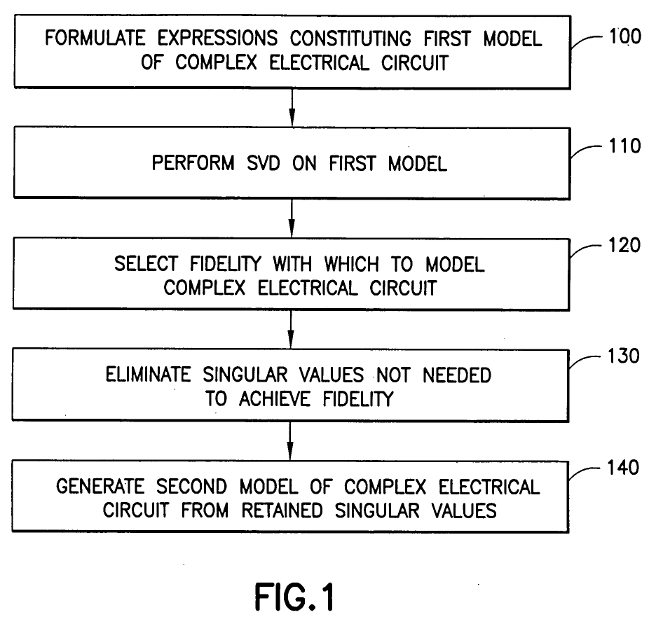

The preceding method is in accordance with various alternate embodiments of the present invention, and one method in accordance with a variant of an alternate embodiment is shown in the block diagram of FIG. 1. In the first step at 100, expressions constituting a first model of the complex electric circuit are formulated. As used herein, “electric circuit” generically refers to electric and electronic circuits. Next, at step 110, singular value decomposition is performed on the first model of the complex electric circuit. Then, the fidelity with which to model the complex electric circuit is selected at step 120. Next, at step 130, singular values revealed by the singular value decomposition operation which are not needed to achieve the desired modeling fidelity are eliminated. Then, at step 140, a second reduced-order model of the complex electric circuit is generated from the retained singular values revealed by the singular value decomposition. The discarded singular values generally correspond to correlated input terminals and/or correlated output terminals.

In a variant of the method depicted in FIG. 1, the reduced-order second model of the complex electric circuit would be generated by discarding the null singular values of the singular value decomposition of the first model, and generating the reduced-order second model from the retained non-zero singular values. In this variant, step 110 need not be performed.

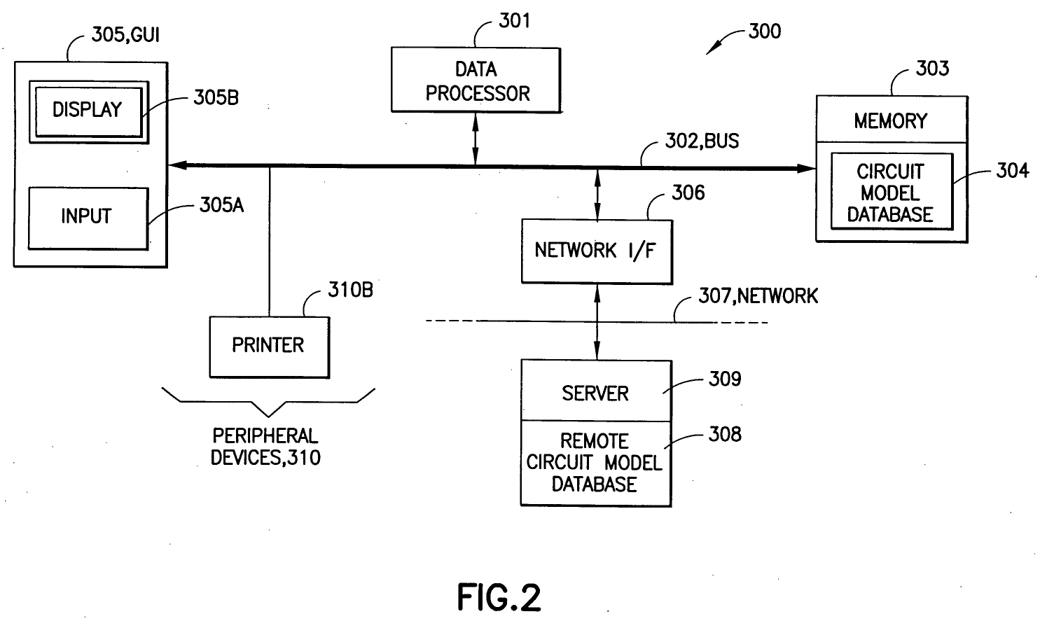

A computer system for practicing the methods of the present invention is depicted in simplified form in FIG. 2. The data processing system 300 includes at least one data processor 301 coupled to a bus 302 through which the data processor 301 may address a memory sub-system 303, also referred to herein simply as the memory 303. The memory 303 may include RAM, ROM and fixed and removable disks and/or tape. The memory 303 is assumed to store at least one program comprising instructions for causing the data processor 301 to execute methods in accordance with the teachings of the invention. Also stored in the memory 303 can be at least one database 304 containing information describing the characteristics of a complex electric circuit to be modeled in accordance with the teachings of the present invention. The data processor 301 is also coupled through the bus 302 to a user interface, preferably a graphical user interface (“GUI”) 305 that includes a user input device 305 A, such as one or more of a keyboard, a mouse, a trackball, a voice recognition interface, as well as a user display device 305 B, such as a high resolution graphical CRT display terminal, a LCD display terminal, or any suitable display device. With these input/output devices, a user can perform the steps of the methods of the present invention where user-specified values are required.

The data processor 301 may also be coupled through the bus 302 to a network interface 306 that provides bidirectional access to a data communications network 307, such as an intranet and/or the internet. In various embodiments of the present invention, a model of a complex electric circuit can be uploaded though the internet for model order reduction performed by one or more programs stored on a remote website. Alternatively, one or more programs capable of performing model order reduction in accordance with the preferred embodiments of the present invention can be downloaded from a remote site to a user's computer.

In general, these teachings may be implemented using at least one software program running on a personal computer, a server, a microcomputer, a mainframe computer, a portable computer, an embedded computer, or by any suitable type of programmable data processor 301. The use of the model order reduction methods of the present invention substantially improves the analysis and simulation of complex electric circuits and linear systems. The methods may be used to perform model order reduction on models of complex electric circuits stored in or referenced by the database 304, or in the remotely stored database 308 over the network 307 and in cooperation with the server 309.

As an example an RC rectangular mesh such as would result from the modeling of an on-chip power grid is analyzed. The grid is quite rectangular, therefore it is expected that the responses of the signals to be highly correlated. It is assumed that all the inputs nodes are on the left side of the mesh and the output on the right side of the mesh. Assuming the mesh is of size 20×50 the transfer function that the reduced-order model needs to capture will be a 20×20 matrix valued transfer function. The zeroth order moment (the DC component) and the first order moment (the Elmore delay) have the following expressions
M₀=L^{T}G⁻¹R
M₁=L^{T}G⁻¹CG⁻¹R (12)

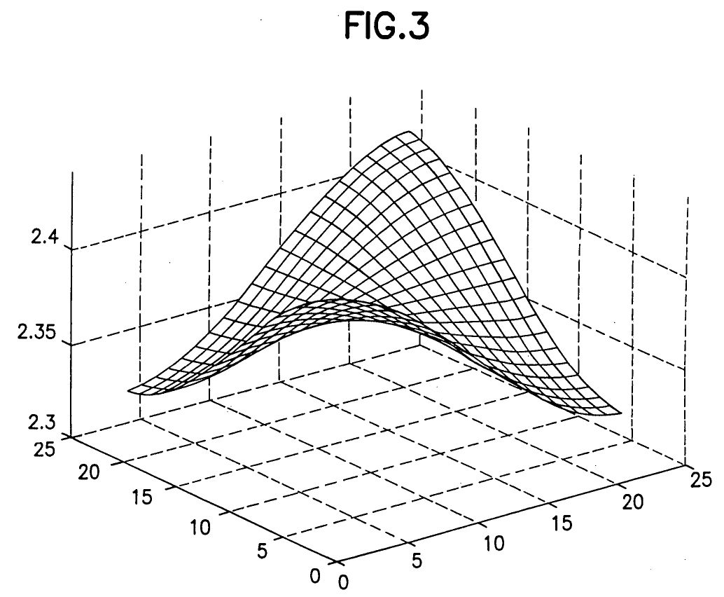

FIGS. 2 and 3 plot the entries of the two moment matrices and show their entries, far from being random, exhibit a high degree of correlation.

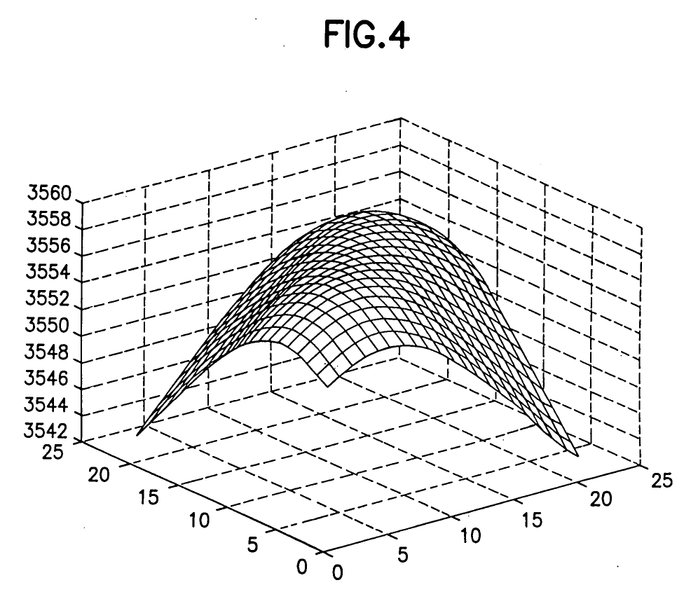

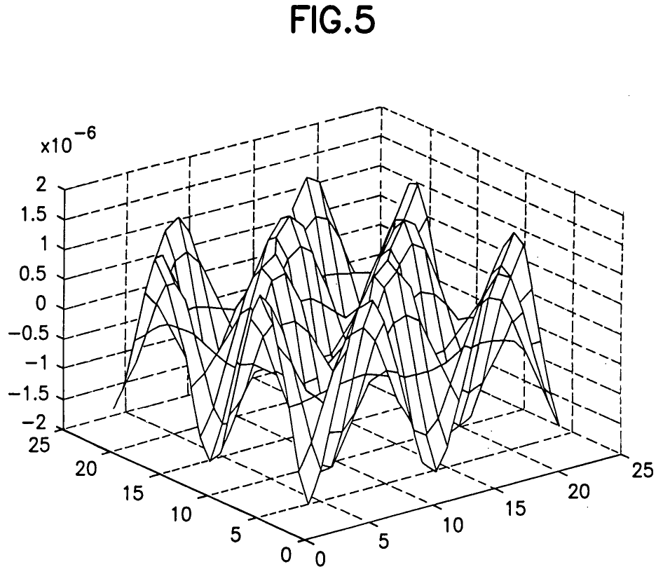

FIG. 4 and 5 show the relative error incurred by a low rank approximation of the two moments. It turns out that a rank-4 sparsification is very accurate.

The methods and apparatus of the present invention can also be used to perform model order reduction on models of complex electric circuits or linear systems representing other moments of the complex electric circuits or linear systems. For example, models representing two or more moments, or frequency-shifted moments can be reduced with the methods and apparatus of the present invention.

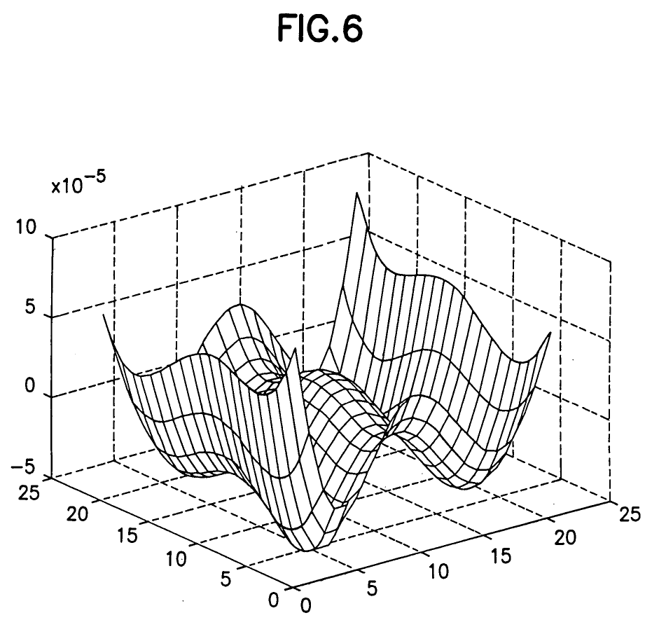

In summary, the moment approach to response simulation generally corresponds to other alternate embodiments of the present invention, and the steps of a method in accordance with a variant of one of these alternate embodiments are depicted in FIG. 6. At step 200, the desired response characteristic (e.g., the DC response) of a complex electric circuit to be modeled is selected. Next, at step 210, expressions of sufficient fidelity to accurately model the selected response characteristic of the complex electric circuit are formulated, wherein the expressions constitute a first model of the complex electric circuit. Then, at step 220, singular value decomposition is performed on the first model of the complex electric circuit. Next, at step 230, the fidelity with which to model the response characteristic of the complex electric circuit is selected. Then, at step 240, the singular values revealed by singular value decomposition not needed to achieve the desired fidelity are eliminated. Next, at step 250, a second reduced-order model of the response characteristic of the complex electric circuit is generated from the retained singular values.

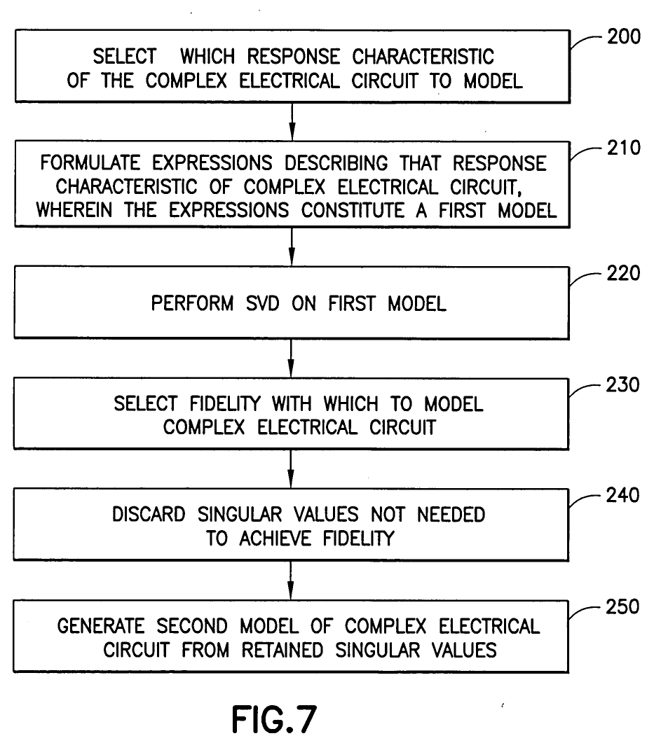

The algorithm described in the previous section produces exactly such a low-rank approximation of matrix moments. FIG. 7 shows the s-domain transfer function of 4 entries of the transfer matrix, chosen to be as different as possible. The solid lines represent the exact response as obtained from solving the 1000-node circuit. The discrete points represent the approximation of the same transfer function by the method of the present invention and by a method in accordance with the prior art. As expected the model sparsified by a method in accordance with the present invention matches the original transfer function quite accurately.

In summary, the present invention concerns methods and apparatus for model order reduction of linear systems characterized by a very large number of terminals. Previously, such systems were not amenable to reduction, since their so-called reduced-order model, could become as complex to store and evaluate as the original un-reduced model. This apparent paradox is explained by the fact that reduced-order models for systems with large number of terminals are based on dense matrices while the original circuit equations are written in terms of sparse matrices albeit much larger.

The methods of the present invention restore the sparsity of the reduced-order model even in cases when the number of terminals is very large. The methods exploit the correlations between circuit responses at various network terminals, and become more efficient as the correlations between circuit responses are more pronounced.

While not a universal property of electric circuits, such correlations are characteristic of large number of practical applications. As the examples analyzed herein indicate, the methods of the present invention are particularly powerful in the analysis of regularly structured circuits, often used in modeling of power grids and buses.

Thus it is seen that the foregoing description has provided by way of exemplary and non-limiting examples a full and informative description of the best method and apparatus presently contemplated by the inventors for performing model order reduction of electric circuits having at least two correlated input terminals or at least two correlated output terminals. One skilled in the art will appreciate that the various embodiments described herein can be practiced individually; in combination with one or more other embodiments described herein; or in combination with model order reduction methods differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

What is claimed is:

1. A signal-bearing medium tangibly embodying a program of machine-readable instructions executable by a digital processing apparatus of a computer system to perform operations comprising model order reduction of a complex electric circuit, the operations comprising:
formulating a set of expressions that describes the input and output characteristics of the complex electric circuit, wherein the set of expressions comprises a first model of the complex electric circuit;
performing mathematical operations on the first model of the electric circuit to determine whether at least one correlation in response behavior exists between at least two input terminals; and, if at least one correlation is found,
generating a reduced-order second model of the electric circuit by removing from the first model aspects associated with correlated input terminals.

2. A signal-bearing medium tangibly embodying a program of machine-readable instructions executable by a digital processing apparatus of a computer system to perform operations comprising model order reduction of a complex electric circuit, the operations comprising:
formulating a set of expressions that describes the input and output characteristics of the complex electric circuit, wherein the set of expressions comprise a first model of the complex electric circuit;
performing mathematical operations on the first model of the electric circuit to determine whether at least one correlation in response behavior exists between at least two output terminals; and, if at least one correlation is found,
generating a reduced-order second model of the electric circuit by removing from the first model aspects associated with correlated output terminals.

3. A signal-bearing medium tangibly embodying a program of machine-readable instructions executable by a digital processing apparatus of a computer system to perform operations comprising model order reduction of a complex electric circuit, the operations comprising:
formulating a set of expressions that describes the input and output characteristics of the complex electric circuit, wherein the set of expressions comprises a first model of the complex electric circuit;
performing mathematical operations on the first model of the complex electric circuit to determine whether at least one correlation in response behavior exists between at least two input terminals or between at least two output terminals;
and, if at least one correlation is found, generating a reduced-order second model of the complex electric circuit by removing from the first model aspects associated with correlated input terminals or correlated output terminals.

4. The signal-bearing medium of claim 3 wherein generating a reduced-order second model further comprises:
substituting a lower rank second model of the complex electric circuit for the first model of the electric circuit.

5. The signal-bearing medium of claim 3 wherein performing mathematical operations on the first model of the complex electric circuit further comprises:
performing linear algebraic manipulations on the first model of the complex electric circuit to reveal at least one correlation between at least two input terminals or between at least two output terminals.

6. The signal-bearing medium of claim 5 wherein performing linear algebraic manipulations further comprises:
performing singular value decomposition on the first model.

7. The signal-bearing medium of claim 6 wherein generating a reduced-order second model of the electric circuit further comprises:
eliminating from the singular value decomposition of the first model of the complex electric circuit null singular values associated with correlated input terminals or correlated output terminals; and
creating a second reduced-order model of the electric circuit from the non-zero singular values of the singular value decomposition of the first model of the complex electric circuit.

8. The signal-bearing medium of claim 6 wherein generating a reduced-order second model of the complex electric circuit further comprises:
selecting a suitable tolerance for modeling the complex electric circuit;
eliminating from the singular value decomposition of the first model of the electric circuit singular values not needed to achieve the desired modeling tolerance; and
creating a second reduced-order model of the complex electric circuit from the retained singular values.

9. A signal-bearing medium tangibly embodying a program of machine-readable instructions executable by a digital processing apparatus of a computer system to perform operations comprising model order reduction of a complex electric circuit, the operations comprising:
selecting which response characteristic of the complex electric circuit to model;
formulating a set of expressions of sufficient accuracy to simulate the selected response characteristic at the input and output terminals of the complex electric circuit, wherein the set of expressions comprises a first model of the electric circuit;
performing mathematical operations on the first model of the electric circuit to determine whether at least one correlation in response behavior exists between at least two input terminals or between at least two output terminals; and, if at least one correlation is found,
generating a reduced-order second model of the electric circuit by removing from the first model aspects associated with correlated input terminals or correlated output terminals.

10. The signal-bearing medium of claim 9 wherein generating a reduced-order second model further comprises:
substituting a lower rank second model of the complex electric circuit for the first model of the complex electric circuit.

11. The signal-bearing medium of claim 9 wherein performing mathematical operations on the first model of the electric circuit further comprises:
performing linear algebraic manipulations on the first model of the complex electric circuit to reveal at least one correlation between at least two input terminals or between at least two output terminals.

12. The signal-bearing medium of claim 11 wherein performing linear algebraic manipulations further comprises:
performing singular value decomposition on the first model.

13. The signal-bearing medium of claim 12 wherein generating a reduced-order second model of the electric circuit further comprises:
eliminating from the singular value decomposition of the first model of the complex electric circuit null singular values associated with correlated input terminals or correlated output terminals; and
creating a second reduced-order model of the electric circuit from the non-zero singular values of the singular value decomposition of the first model of the electric circuit.

14. The signal-bearing medium of claim 12 wherein generating a reduced-order second model of the electric circuit further comprises:
selecting a suitable tolerance for modeling the complex electric circuit;
eliminating from the singular value decomposition of the first model of the electric circuit singular values not needed to achieve the desired modeling tolerance; and
creating a second reduced-order model of the complex electric circuit from the retained singular values.

15. A method for determining a reduced-order model of a complex electric circuit, the method comprising:
formulating a set of expressions that describes the input and output characteristics of the complex electric circuit, wherein the set of expressions comprises a first model of the electric circuit;
performing mathematical operations on the first model of the electric circuit to determine the identity of at least two input terminals which are correlated in their response behavior and the identity of at least two output terminals which are correlated in their response behavior; and
generating a reduced-order second model of the electric circuit by eliminating from the first model aspects associated with correlated input terminals and correlated output terminals.

16. The method of claim 15 wherein generating a reduced-order second model further comprises:
substituting a lower rank second model of the complex electric circuit for the first model of the complex electric circuit.

17. The method of claim 15 wherein performing mathematical operations on the first model of the electric circuit further comprises:
performing linear algebraic manipulations on the first model of the electric circuit to reveal correlations between at least two input terminals and correlations between at least two output terminals.

18. The method of claim 17 wherein performing linear algebraic manipulations further comprises:
performing singular value decomposition on the first model.

19. The method of claim 18 wherein generating a reduced-order second model of the electric circuit further comprises:
eliminating from the singular value decomposition of the first model of the electric circuit null singular values associated with correlated input terminals and correlated output terminals; and
creating a second reduced-order model of the electric circuit from the non-zero singular values of the singular value decomposition of the first model of the electric circuit.

20. The method of claim 18 wherein generating a reduced-order second model of the electric circuit further comprises:
selecting a suitable tolerance for modeling the complex electric circuit;
eliminating from the singular value decomposition of the first model of the electric circuit singular values not needed to achieve the desired modeling tolerance; and
creating a second reduced-order model of the electric circuit from the retained singular values.

21. A method for determining a reduced-order model of a complex electric circuit, the method comprising:
selecting which response characteristics of the complex electric circuit to model;
formulating a set of expressions of sufficient accuracy to simulate the selected response characteristics at the input and output terminals of the complex electric circuit, wherein the set of expressions comprises a first model of the electric circuit;
performing mathematical operations on the first model of the electric circuit to determine the identity of at least two input terminals which are correlated in their response behavior and the identity of at least two output terminals which are correlated in their response behavior; and
generating a reduced-order second model of the electric circuit by eliminating from the first model aspects associated with the correlated input terminals and correlated output terminals.

22. The method of claim 21 wherein generating a reduced-order second model further comprises:
substituting a lower rank second model of the complex electric circuit for the first model of the complex electric circuit.

23. The method of claim 21 wherein performing mathematical operations on the first model of the electric circuit further comprises:
performing linear algebraic manipulations on the first model of the electric circuit to reveal correlations between input terminals and correlations between output terminals.

24. The method of claim 23 wherein performing linear algebraic manipulations further comprises:
performing singular value decomposition on the first model.

25. The method of claim 24 wherein generating a reduced-order second model of the electric circuit further comprises:
eliminating from the singular value decomposition of the first model of the complex electric circuit null singular values associated with correlated input terminals and correlated output terminals; and
creating a second reduced-order model of the electric circuit from the non-zero singular values of the singular value decomposition of the first model of the electric circuit.

26. The method of claim 24 wherein generating a reduced-order second model of the electric circuit further comprises:
selecting a suitable tolerance for modeling the complex electric circuit;
eliminating from the singular value decomposition of the first model of the electric circuit singular values not needed to achieve the desired modeling tolerance; and
creating a second reduced-order model of the complex electric circuit from the retained singular values.

27. A computer system for performing model order reduction on a model of a complex electric circuit, the computer system comprising:
at least one memory to store at least (1) a description of the complex electric circuit and (2) at least one program of machine readable instructions comprising operations which perform model order reduction on models of complex electric circuits when the at least one program is executed;
at least one processor coupled to the at least one memory, wherein the at least one processor performs at least the following operations when the at least one program is executed:
formulating a set of expressions from the description of the complex electric circuit that describes the input and output characteristics of the circuit, wherein the set of expressions comprises a first model of the complex electric circuit;
performing mathematical operations on the first model of the complex electric circuit to determine whether at least one correlation in response behavior exists between at least two input terminals or between at least two output terminals; and, if at least one correlation is found,
generating a reduced-order second model of the complex electric circuit by removing from the first model aspects associated with correlated input terminals or correlated output terminals.

28. The computer system for performing model order reduction of claim 27, where generating a reduced-order model further comprises:
substituting a lower rank second model of the complex electric circuit for the first model of the complex electric circuit.

29. The computer system for performing model order reduction of claim 27, where performing mathematical operations on the first model of the complex electric circuit further comprises:
performing linear algebraic manipulations on the first model of the complex electric circuit to reveal at least one correlation between at least two input terminals or between at least two output terminals.

30. The computer system for performing model order reduction of claim 29 where performing linear algebraic manipulations on the first model of the complex electric circuit further comprises:
performing singular value decomposition on the first model of the complex electric circuit.

31. The computer system for performing model order reduction of claim 30 where generating a reduced-order second model of the complex electric circuit further comprises:
eliminating from the singular value decomposition of the first model of the complex electric circuit null singular values associated with correlated input terminals or correlated output terminals; and
creating a second reduced-order model of the complex electric circuit from the non-zero singular values of the singular value decomposition of the first model of the electric circuit.

32. The computer system for performing model order reduction of claim 30 where generating a reduced-order second model of the complex electric circuit further comprises:
recalling a specified tolerance for modeling the complex electric circuit;
eliminating from the singular value decomposition of the first model of the complex electric circuit singular values not needed to achieve the desired modeling tolerance; and
creating a second reduced-order model of the complex electric circuit from the retained singular values.

33. The computer system for performing model order reduction of claim 27 wherein the at least one memory comprises at least one remote database accessible over the internet, wherein the description of the complex electric circuit is stored in the at least one remote database.

34. The computer system for performing model order reduction of claim 27 wherein the at least one memory comprises at least one remote database accessible over the internet, wherein the at least one program for performing model order reduction is stored in the at least one remote database.

35. A computer system for performing model order reduction on a model of a complex electric circuit, the computer system comprising:
at least one memory to store at least (1) a description of the complex electric circuit and (2) at least one program of machine readable instructions comprising operations which perform model order reduction on models of complex electric circuits when executed;
at least one processor coupled to the at least one memory, wherein the at least one processor performs at least the following operations when the at least one program is executed:
recalling a user-specified selection corresponding to a desired response characteristic of the complex electric circuit; wherein that desired response characteristic of the complex electric circuit will be modeled by the computer system;
formulating a set of expressions of sufficient accuracy to simulate the selected response characteristic at the input and output terminals of the complex electric circuit, wherein the set of equations comprises a first model of the electric circuit;
performing mathematical operations on the first model of the complex electric circuit to determine whether at least one correlation in response behavior exists between at least two input terminals or between at least two output terminals; and, if at least one correlation is found,
generating a reduced-order second model of the complex electric circuit by removing from the first model aspects associated with correlated input terminals or correlated output terminals.

36. The computer system for performing model order reduction of claim 35 where generating a reduced-order second model of the complex electric circuit further comprises:
substituting a lower rank second model of the complex electric circuit for the first model of the complex electric circuit.

37. The computer system for performing model order reduction of claim 35 where performing mathematical operations on the first model of the complex electric circuit further comprise:
performing linear algebraic manipulations on the first model of the complex electric circuit to reveal at least one correlation between at least two input terminals or between at least two output terminals.

38. The computer system for performing model order reduction of claim 37 where performing linear algebraic manipulations on the first model of the complex electric circuit further comprises:
performing singular value decomposition on the first model of the complex electric circuit.

39. The computer system for performing model order reduction of claim 38 where generating a reduced-order second model of the complex electric circuit further comprises:
eliminating from the singular value decomposition of the first model of the complex electric circuit null singular values associated with correlated input terminals or correlated output terminals; and
creating a second reduced-order model of the complex electric circuit from the non-zero singular values of the singular value decomposition of the first model of the electric circuit.

40. The computer system for performing model order reduction of claim 38 where generating a reduced-order second model of the complex electric circuit further comprises:
recalling a user-specified tolerance for modeling the complex electric circuit;
eliminating from the singular value decomposition of the first model of the complex electric circuit singular values not needed to achieve the desired modeling tolerance; and
creating a second reduced-order model of the complex electric circuit from the retained singular values.

41. The computer system for performing model order reduction of claim 35 wherein the desired response characteristic corresponds to the DC response of the complex electric circuit.

42. The computer system for performing model order reduction of claim 35 wherein the desired response characteristic corresponds to the delay response of the complex electric circuit.

43. The computer system for performing model order reduction of claim 3 5 wherein the desired response characteristic corresponds to the DC and delay response of the complex electric circuit.

44. The computer system for performing model order reduction of claim 35 wherein the desired response characteristic corresponds to a frequency-shifted moment of the complex electric circuit.

45. A signal-bearing medium tangibly embodying a program of machine-readable instructions executable by a digital processing apparatus of a computer system to perform operations comprising model order reduction of a linear system, the operations comprising:
formulating a set of expressions that describe the input and output characteristics of the linear system, wherein the set of expressions comprise a first model of the linear system;
performing mathematical operations on the first model of the linear system to determine whether at least one correlation in response behavior exists between at least two inputs or between at least two outputs; and, if at least one correlation is found,
generating a reduced-order second model of the linear system by removing from the first model aspects associated with correlated inputs or correlated outputs.

46. The signal-bearing medium of claim 45 wherein the linear system further comprises an analogue system.

47. The signal-bearing medium of claim 45 wherein the linear system further comprises a discrete system.
